(19) United States
(12) Patent Application Publication
(10) Pub. No.: US 2008/0097866 A1
(43) Pub. Date: Apr. 24, 2008

(54) Guarantying payment for transactions

(75) Inventors: Rui Miguel Frazao Dias Ferreira, (US); Antonio Paulo Riveiro Conde, (US); Bruno Jorge Monteiro Salgueiro de Jesus Ferreira, (US); Luis Pedro Fonseca da Silva, (US)

Correspondence Address: FISH & RICHARDSON PC, P.O. BOX 1022, MINNEAPOLIS, MN, 55440-1022, US

(73) Assignee: Conduct Prosecution

(21) Appl. No.: 11/583,506

(22) Filed: Oct. 19, 2006

(51) Int. Cl. G06Q 30/00

(52) U.S. Cl. 705/26

(57) ABSTRACT

Techniques for guaranteeing payment to a seller of a commodity purchased by a buyer are described. A selection of a sales proposal for purchasing the commodity from the seller is received. The sales proposal specifies the conditions under which the commodity will be delivered to the buyer. The seller is then notified that the sales proposal has been selected by the buyer, and a payment agreement is provided to the seller. The payment agreement specifies financial terms under which a financial institution guarantees payment to the seller on behalf of the buyer for future deliveries of the commodity in accordance with the sales proposal.

### TECHNICAL FIELD

This invention relates to guarantying a transaction, and more particularly to guarantying electronic-commerce transactions.

### BACKGROUND

“Guarantying” is a service in which a financial institution, by order of a buyer, guarantees payment to a seller for commodities purchased by the buyer. In an electronic-commerce setting, electronic purchases are often guaranteed by either a credit card or similar product or through other traditional non-electronic methods such as the issuance of a promissory note. Electronic-commerce (“e-commerce”) refers to business transactions between buyers and sellers that are wholly or partially conducted over the Internet, World Wide Web, or similar public or private computer networks.

### SUMMARY

The invention provides apparatuses and methods, including computer program products, for guaranteeing payment to a seller of a commodity purchased by a buyer.

In general, in one aspect, the invention features a method and computer program product in which a selection of a sales proposal for purchasing the commodity from the seller is received from a buyer. The sales proposal specifies conditions under which the commodity will be delivered to the buyer. The seller is notified that the sales proposal has been selected by the buyer and is provided a payment agreement specifying financial terms under which a financial institution guarantees payment to the seller on behalf of the buyer for future deliveries of the commodity in accordance with the sales proposal, the payment agreement being approved by the buyer and the financial institution. An acceptance of the payment agreement is received from the seller. The buyer, the seller, and the financial institution are then notified that future deliveries of the commodity, as defined in the sales proposal, will be paid by the financial institution according to the payment agreement.

In another aspect, the invention features an apparatus for guaranteeing payment to a seller for a commodity purchased by a buyer. The apparatus includes a processor operable to execute a computer program for facilitating transactions between the buyer, the seller, and a financial institution; memory coupled to the processor, the memory operable to store the computer program; and a communication device operable to: transmit information between a first client device and the processor, the first client device being operating by the buyer; transmit information between a second client device and the processor, the second client device being operated by the seller; and transmit information between a third client device and the processor, the third client device being operated by the financial institution. The computer program includes computer instructions to cause the processor to: receive selection data from the first client device, the selection data including a selection of a sales proposal made by the buyer for purchasing a commodity from the seller, the sales proposal specifying conditions under which the commodity will be delivered to the buyer; transmit first notification data to the second client device, the first notification data notifying the seller that the sales proposal has been selected by the buyer; transmit payment agreement data to the second client device, the payment agreement data specifying financial terms under which the financial institution guarantees payment to the seller on behalf of the buyer for future deliveries of the commodity in accordance with the sales proposal, the financial terms being approved by the buyer; receive acceptance data from the second client device, the acceptance data indicating acceptance of the payment agreement by the seller; and transmit second notification data to the first, second, and third clients, the second notification data notifying the buyer, the seller, and the financial institution that future deliveries of the commodity, as defined in the sales proposal, will be paid by the financial institution according to the financial terms.

Embodiments may include one or more of the following. The buyer may be enabled to view a plurality of sales proposals for purchasing commodities from a plurality of different sellers. The buyer and the seller may negotiate terms of the sales proposal. The conditions specified in the sales proposal may include one or more of: a payment date, a delivery date, and a distribution of deliveries. The seller may be invited to put the sales proposal under the payment agreement. Payment from the buyer may be received in return for providing the buyer access to a plurality of sales proposals made available by different sellers, the access to the plurality of sales proposals being provided over a predetermined period of time. Payment from the seller may be received in return for providing different buyers access to the sales proposal offered by the seller, the access to the sales proposal being provided over a predetermined period of time.

A network may be connected to the communication device and to the first, second, and third client devices and may including the Internet and the World Wide Web. The computer program may include further instructions to cause the processor to operate a web site portal through which the buyer, the seller, and the financial institution interact with each other. The first, second, and third client devices may store first, second, and third digital certificates that include personal identification used by the processor to electronically verify the identities of the buyer, the seller, and the financial institution. The computer program may include further instructions to: cause the processor to authenticate the buyer using an encrypted username and password supplied by the buyer; enable the buyer to view, at the first client device, a plurality of sales proposals for purchasing commodities from a plurality of different sellers; enable the buyer and the seller to negotiate terms of the sales proposal; and/or store the conditions of the sales proposal in the memory, the conditions including one or more of: a payment date, a delivery date, and a distribution of deliveries. The first notification data may include an invitation to the seller to put the sales proposal under the payment agreement.

Advantages that can be seen in some embodiments include one or more of the following. A guarantying service can guarantee payment to a seller for future deliveries of a commodity at the time of purchase. Deliveries may be confirmed electronically by the buyer while payments may be confirmed electronically by the seller. Since the guarantying service is supported electronically, the e-commerce's sphere of activity can be broadened, covering the entire business process of consultation, purchase, delivery, and payment. Since the guarantying service operates in an electronic marketplace, various information systems provided to the users of the service (e.g., buyers, sellers, and financial institutions) can be integrated with benefits for all those involved. An electronic platform enables a buyer and a seller to negotiate the terms of a purchase agreement. The guarantying service may be used to guaranty credit sales between parties in electronic commerce; support payments for purchases with multiple deliveries spread out over time; and provide comprehensive supply management and payment processes by electronic means. The guarantying service reduces credit risk associated with transactions between a buyer and seller. When the transaction involves multiple deliveries, credit risk may be covered delivery by delivery (invoice by invoice).

The guarantying service enables a seller to enter into a payment agreement under which a financial institution guarantees payment to the seller, on behalf of a buyer, for future deliveries of a commodity purchased by the buyer. Once deliveries have been made (compete or partial), the guarantying services enables a buyer to check the deliveries against the original purchase agreement. On the invoice due dates, the guarantying service guarantees payment to the seller regardless of whether the financial institution has received payment from the buyer.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of guarantying system.

FIG. 2 is a block diagram of a service platform for use with the guarantying system of FIG. 1.

FIG. 3 is a block diagram of a client device for use with the guarantying system of FIG. 1.

FIGS. 4A-B is a flow chart depicting an agreement entry process and a corresponding server process performed by the service platform of FIG. 2.

FIGS. 5A-B is a flow chart depicting an invoice payment procedure and a corresponding server process performed by the service platform of FIG. 2.

### DETAILED DESCRIPTION

In many credit-based transactions between a buyer and a seller, a buyer purchases a commodity (i.e., goods or services) from a seller under a promise or guarantee to pay for the commodity at a future date from the time of purchase, and the seller agrees to provide the commodity to the buyer at a future date from the time of purchase. This is especially true for e-commerce transactions. For example, a buyer may purchase a commodity (e.g., books or moving services) from a website and guarantee payment of the purchase using a credit card or similar products (e.g., PayPal®) or using other traditional, non-electronic methods.

In some credit-based transactions, conventional guarantying systems do not begin working until the seller issues an invoice after the commodity has been delivered. With these traditional systems, credit risk (i.e., the risk that the promised payment will not be received) is born by the seller at the time of delivery. That is, if the guarantying method of the buyer fails, for example, the credit card used by the buyer turns out to be stolen, the seller must either assume the loss or undertake legal action to recoup payment from the buyer or to repossess the commodity, which can be time-consuming and costly. The credit risk to the seller is often greater if the transaction involves multiple deliveries covered by a single purchase. In credit-based transactions in which the seller receives payment from the buyer before delivering the commodity, the buyer is exposed to financial risk. In particular, after the buyer has assumed responsibility for payment of the purchase, the buyer runs the risk of the seller failing to delivery the commodity according to the agreed upon terms of the transaction. For example, the delivery may be incorrect or incomplete, or the seller may fail to deliver the commodity on the agreed upon date or fail to deliver the commodity altogether. If there is any time lag between the supply agreement and delivery of the commodity, financial risk is assumed by the buyer once the order is accepted and not when it is delivered.

The present invention provides a “guarantying service” for reducing exposure of both buyers and sellers to financial risk associated with business transactions, particularly e-commerce transactions. The guarantying service reduces the financial risk born by a seller by enabling a financial institution to guaranty future payment to the seller on behalf of the buyer at a specified date regardless of whether or not the buyer has sufficient funds available on that date. The guarantying service also reduces the financial risk born by a buyer by authorizing a financial institution to send payment to the seller only after receiving verification from the buyer that the delivery of the commodity is complete and accurate.

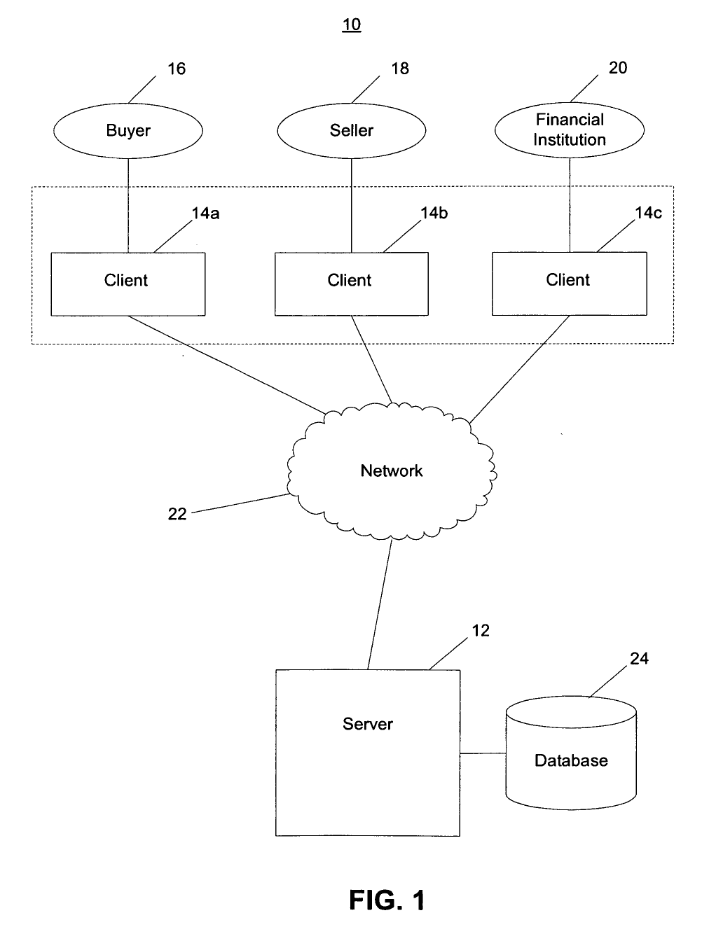

Referring to FIG. 1, a guarantying system 10 for implementing the guarantying service and facilitating transactions under agreements thereof, includes first, second, and third client devices 14a-c (collectively referred to as “client devices 14”); a guaranteeing service platform 12 (service platform 12) coupled to the client devices 14 via a network 22; and a database 24 coupled to service platform 12. Service platform 12 serves as an electronic marketplace for facilitating electronic transactions between users of the guarantying service. Users include buyers, sellers, and financial institutions. A buyer 16, a seller 18, and a financial institution 20 access the service platform 12 using the first, second, and third client devices 14a-c, respectively. Seller 18 may be any entity that offers commodities (i.e., goods or services) for sale, and buyer 16 may be any entity that purchases commodities from one or more sellers (e.g., seller 14). Buyer 16 and seller 18 may be individuals, groups of individuals, companies, organizations, corporations, and the like. Financial institution 20 may be any agent that provides financial services, including lending money, issuing credit, and providing other means of financing to its clients. Examples of financial institution 20 include, but are not limited to, commercial banks, thrifts, federal and state savings banks, saving and loan associations, and credit unions.

When a user signs up for the guarantying service, the user designates itself as either a buyer or a seller. In some embodiments, the user may be designated as both a buyer and a seller (e.g., a retailer who buys products in large quantities through a wholesaler, and then sells the products to the general public or to end-user customers). When a user (e.g., a company) subscribes to the guarantying service, the user assigns individual authorizations to those employees who will act on behalf of the user. Thus a reference to a user (e.g., a buyer) is an implicit reference to an individual person or group of persons who are authorized to act on behalf of the user. Likewise, the first, second, and third client devices 14a-c may each include multiple client devices for use by individuals acting on behalf of the user of that client device. For example, buyer 16 may be an organization, and the first client device 14a may include multiple client devices that are used by individuals working on behalf of buyer 16.

Network 22 can be any type of network such as a public network such as the Internet or telephone system or a private network such as a local area network (LAN), wide area network (WAN), virtual private network (VPN), and so forth. Network 22 may include a variety of network of devices, including servers, routers, and other network devices that are generally known in the art. Network 22 uses one or more communication protocols (e.g., the TCP/IP network protocols) to exchange data between client devices 14 and service platform 12.

Database 24 is an organized collection of information records that can be accessed electronically by the service platform 12. The information stored in the database 24 includes accounts belonging to users of the guarantying system, records showing the past and present activity of the users, and other information related to transactions performed by the users. Database 24 may be implemented as a memory-mapped database or as a relational database and may encompass multiple databases. Database 24 may be stored within service platform 12 or external to service platform 12 on one or more machines in communication with service platform 12.

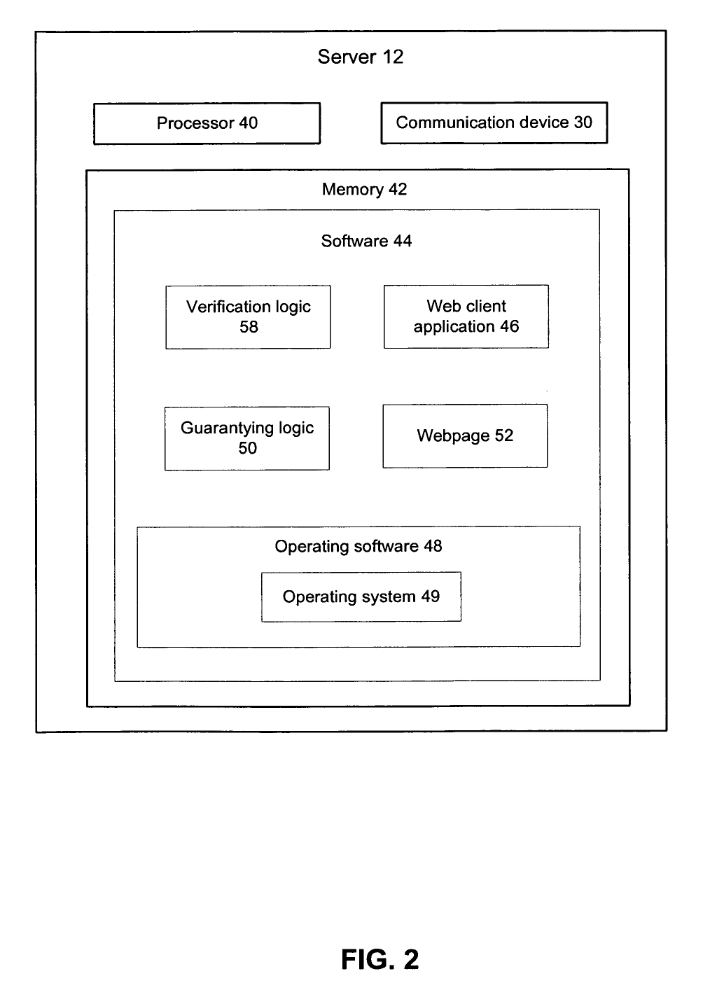

Referring to FIG. 2, service platform 12 may be any type of computing device or multiple computing devices. Service platform 12 includes one or more processor(s) 40 (referred to simply as “processor 40”), a communication device 30, and memory 42 that executes software 44. Communication device 30 converts information to a form that is suitable for transmission over network 22 at a speed of at least 128 kbps (e.g., at speeds of 256 kbps, 3 Mbps, or 10 Mbps). In some implementations, communication device 30 is a modem that converts digital signals into analog sound signals for transmission over a telephone line. In other implementations, communication device 30 is an Ethernet card that converts information into packets for transmission over an Ethernet LAN. Other examples of communication device 30 include wireless access cards, and other network access hardware.

Software 44 includes verification logic 58 for authenticating users, guarantying logic 50 for performing guarantying-service processes, a Web portal 52 for interfacing with users, and a Web client application 46 for enabling communication with the client devices 14. Web client application 46 includes one or more routines used in implementing communication protocols (e.g., TCP/IP protocols) that allow client computer 14a to communicate over network 22 using communication device 30. Service platform 12 also includes an operating system software environment 48 that includes, but that is not necessarily limited to, an operating system 49, such as Windows XP®.

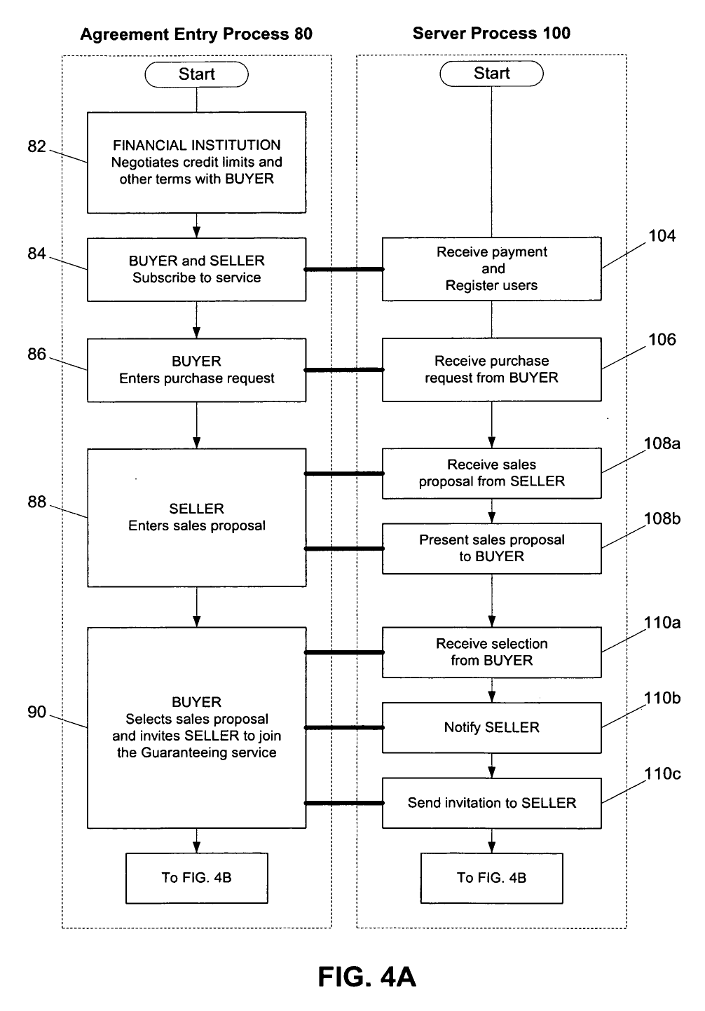

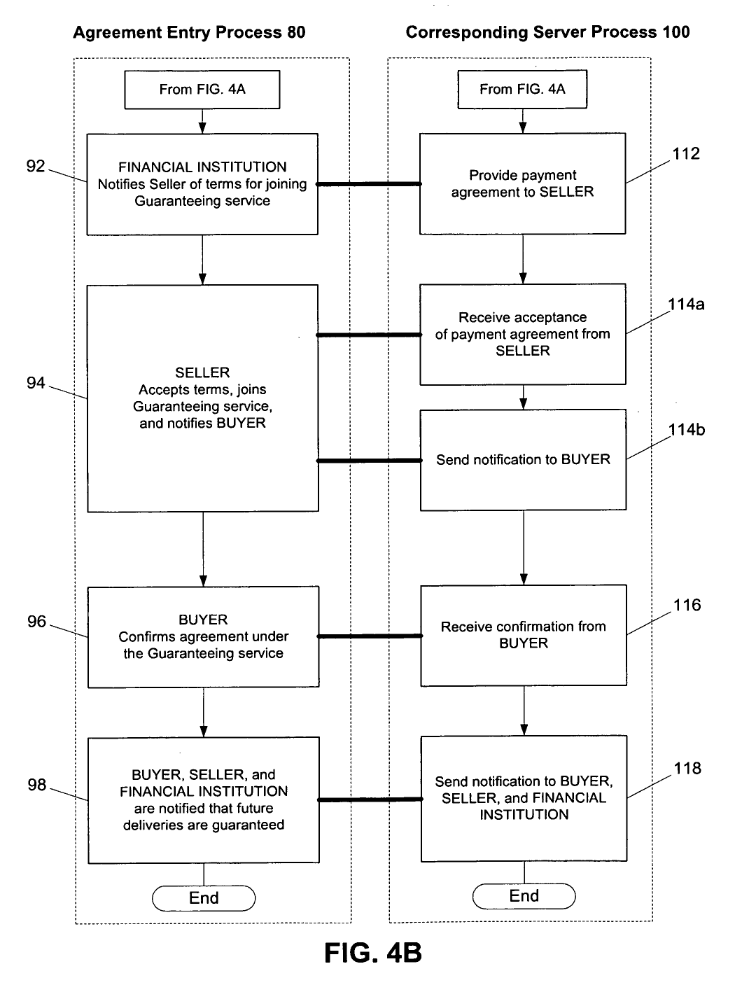

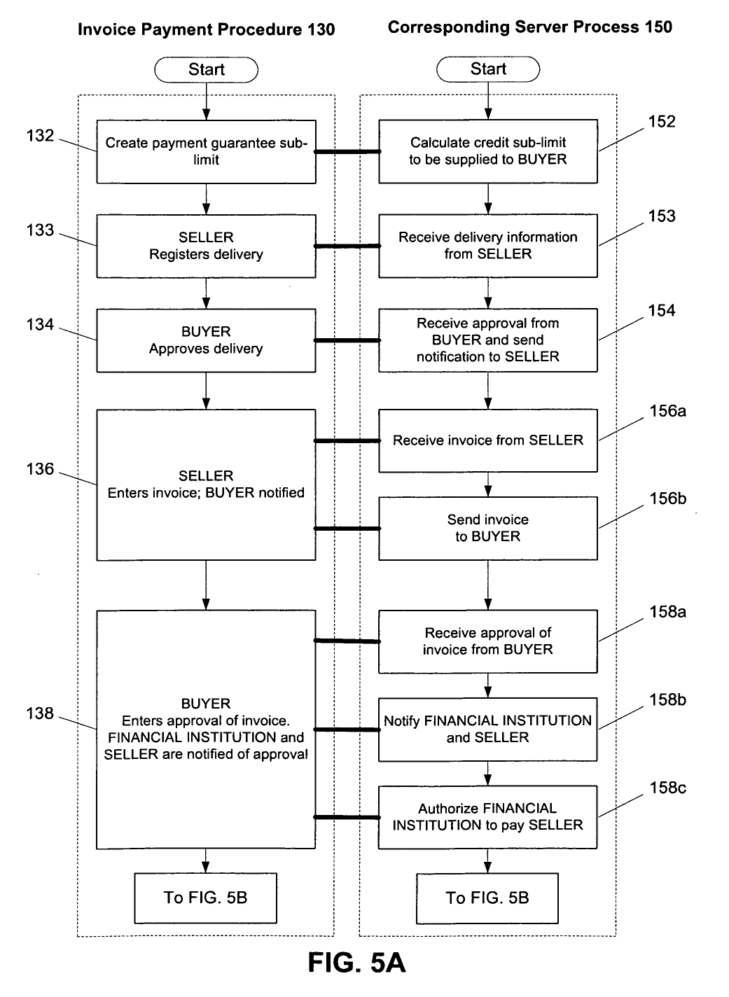

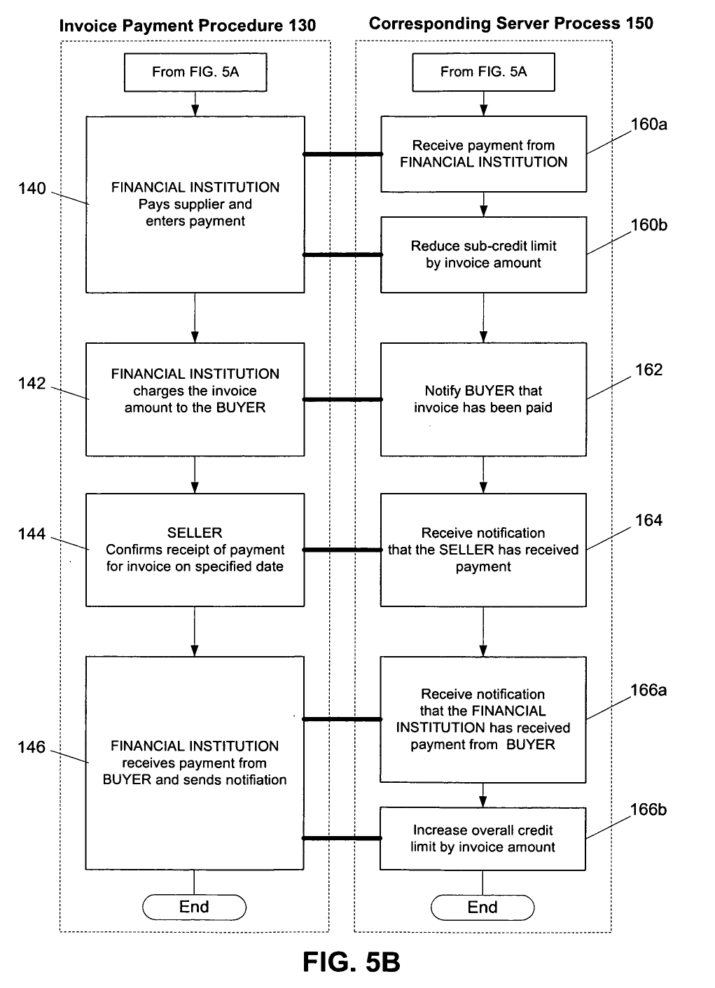

Guarantying logic 50 performs functions necessary to implement the guaranteeing service. For example, guarantying logic 50 registers users, receives sales proposals from sellers and presents them to buyers, facilitates the negotiation of payment agreements between financial institutions and sellers, performs financial transactions between users, records user activity, maintains user accounts, etc. These and other functions performed by the guarantying logic 50 are further described with respect to FIGS. 4A-B and with respect to FIGS. 5A-B.

The Web portal 52 is a group of web pages (i.e., electronic documents) that provides users with an interface to access the guarantying service via the Internet and/or World Wide Web. The Web portal 52 provides the user with tools for customizing the display of information, e.g., sorting, filtering, and indexing information.

Verification logic 58 receives authentication information entered by a user trying to access the guarantying service through Web portal 52. The authentication information includes a username and password. The authentication information may also include digital certificates that allow verification logic 58 to authenticate the identity of the user via third party verification from an independent certificate authority. Authentication using digital certificates in addition to a username and password often provides a higher level security than authentication using a username and password alone. After verifying the identity of the user, the verification logic 58 grants the user access to Web portal 52, through which the user accesses the guarantying service.

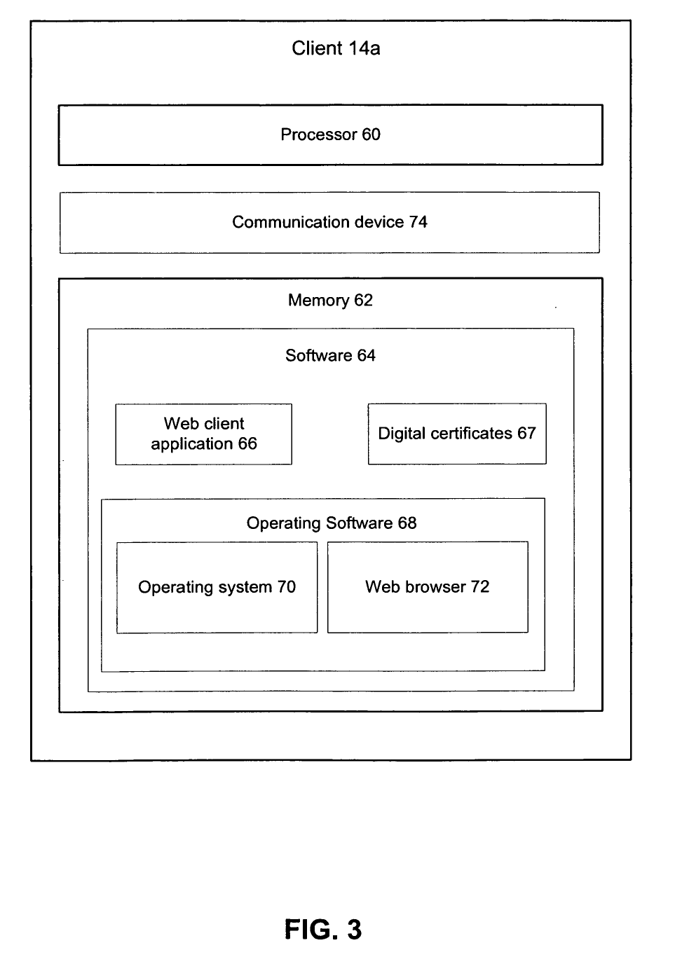

Referring to FIG. 3, client device 14a is shown in further detail. Client devices 14b-c are analogous to client device 14a and thus include the same or similar components shown in FIG. 3 for client device 14a. In some examples, the client devices 14 may be any type of web-enabled apparatus or system including but not limited to a desktop computer, a laptop computer, a mainframe computer, a cellular telephone, a personal digital assistant (“PDA”), and a controller embedded in an otherwise non-computing device. Client device 14a includes one or more processor(s) 60 (referred to simply as “processor 60”), a communication device 74, and memory 62 for storing software 64 and digital certificates 67.

Communication device 74 converts information to a form that is suitable for transmission over network 22 at a speed of at least 128 kbps (e.g., at speeds of 256 kbps, 3 Mbps, or 10 Mbps). In some implementations, communication device 74 is a modem that converts digital signals into analog sound signals for transmission over a telephone line. In other implementations, communication device 74 is an Ethernet card that converts information into packets for transmission over an Ethernet LAN. Other examples of communication device 74 include wireless access cards, and other network access hardware.

Digital certificates 67 serve as an electronic identification card that authenticates a web site when doing business or other transactions over network 22. Digital certificates 67 are issued by a certification authority, such as Entrust® or Verisign®, and include, among other information, a name, a serial number, expiration dates and a digital signature of the certification authority, so that a recipient can verify that the certificate is genuine. In some embodiments digital certificates 67 are secure-socket-layer (SSL) digital certificates of the standard X.509˜3 type.

Processor 60 executes software 64, which includes a Web client application 66 and operating software 68. Web client application 66 includes one or more routines used in implementing one or more communication protocols (e.g., the TCP/IP protocols), which allow client device 14a to communicate over network 22 to service platform 12 using communication device 74. Operating software 68 includes an operating system 70, such as Windows XP®, and a web browser 72, such as Internet Explorer®. Web browser 72 enables the user (i.e., buyer 16, seller 18, or financial institution 20) to interact with web pages provided by Web portal 52. Although loosely described as a client-server model system 10 can be implemented in other configurations.

Referring now to FIGS. 4A-4B, an agreement entry process 80 by which financial institution 20 guarantees seller 18 payment for a commodity purchased by buyer 16 is described. A corresponding server process 100 performed by the guarantying logic 50 operating in combination with the verification logic 58, the Web client application 46, and the Web portal 52 is shown along side agreement entry process 80. A solid line connects each step of agreement entry process 80 to one or more corresponding steps of server process 100. Server process 100 may perform multiple steps to implement a single step of agreement entry process 80. Server process 100 is preferably executed on server computer 12, though some or all of the steps of server process 100 could be executed on one or more client devices 14.

Financial institution 20 and buyer 16 negotiate the financial terms of a payment agreement under which financial institution 20 guarantees payment of commodities purchased by buyer 16 (step 82). The payment agreement specifies an overall credit limit of credit that financial institution 20 will supply to buyer 16 and any interest or fees to be paid by buyer 16 for using credit up to the overall credit limit.

Buyer 16 and seller 12 subscribe to the guarantying service by means of formal service agreements with the party operating or managing service platform 12 (step 84). In some embodiments, buyer 16 and seller 12 purchase subscriptions that grant access to the guarantying service for a predetermined period of time (e.g., a week, month, year, or several years), after which buyer 16 and seller 12 may renew their subscriptions or discontinue the guarantying service. In some embodiments, financial institution 20 also purchases a subscription to participate in the guarantying service. In other embodiments, users pay a fee each time they access the guarantying service through Web portal 52.

During the subscription process (step 84), buyer 16 and seller 18 each designates itself as either a buyer or a seller and assigns individual employee authorizations. The server process 100 receives payment from buyer 16 and seller 18 and registers them as users (step 104). During registration, the server process 100 assigns authentication information to users for allowing them to access the guarantying service via Web portal 52. Access may be controlled using an encrypted username and password system, a digital certificate authentication system, or both. After logging in, users communicate with the web portal 52 through their browser using a message system that invokes a secure communication protocol (e.g., HTTPS protocol). For users with digital signatures, the service platform 12 is also equipped to use digital signature certificates (e.g., standard X.509˜3 type digital certificates) to sign all information exchanged between users. After the verification logic 58 verifies the user's authentication information, the service platform 12 grants the user access to the Web portal 52.

After accessing the Web portal 52, buyer 16 enters a purchase request that includes the types of commodities that buyer 16 is interested in purchasing (step 86). Server process 100 receives the purchase request from the buyer 16 and stores in database 24 as a record linked to the account of buyer 16 (step 106). After accessing the Web portal 52, seller 18 enters sales proposals into a console provided by the Web portal 52 (step 88). The sales proposals include a description and price of a commodity offered for sale and conditions under which a buyer may purchase the commodity. The conditions specified in the sales proposal include one or more of: a payment date on which seller 18 receives payment for delivering the commodity to a buyer, a delivery date on which seller 18 will deliver the commodity to the buyer, and a distribution of delivery dates if the purchase includes multiple deliveries of the commodity.

Server process 100 receives the sales proposals entered by seller 18 and stores them in database 24 (step 108a). Server process 100 then presents to buyer 16 the sales proposals (step 108b) that correspond to the buyer's purchase request. In some embodiments, the Web portal 52 provides buyer 16 with tools to sort various sales proposals by commodity, price, seller, etc; extract proposals of interest, and eliminate proposals that are not of interest. Buyer 16 selects the most competitive proposal from among those received and invites seller 12 to put the proposal under the guarantying service (step 90). A sales proposal that has been accepted by buyer 16 may also be referred to as a “supply agreement.” Server process 100 receives the selection from buyer 16 (step 110a); notifies seller 18 that the sales proposal has been selected (step 110b); and sends an invitation to seller 18 to accept the terms of the payment agreement that was previously negotiated between buyer 16 and financial institution 20 (step 110c). Seller 12 requests quotes from financial institution 20 regarding the payment agreement.

Financial institution 20 notifies the seller 18 of the terms of the payment agreement through the service platform 12 (step 92). The server process 100 provides the payment agreement to the seller 18 on behalf of financial institution 20 (step 112). In some embodiments, the server process 100 sends the payment agreement to seller 12 as an electronic file that can be displayed on the second client device 14b within Web portal 52. Seller 18 accepts the terms of the payment agreement and notifies buyer 16 that the payment agreement has been accepted (step 94). Once seller 18 has accepted the terms of the payment agreement, server process 100 receives the acceptance of the payment agreement from seller 18 (step 114a) and sends notification to buyer 16 informing buyer 16 that the payment agreement has been accepted by seller 18 (step 114b). Buyer 16 confirms the payment agreement under the guarantying service (step 96). In some embodiments, Web portal 52 prompts buyer 16 to engage a portion of the webpage to confirm approval of the payment agreement (e.g., by clicking on a button or entering text into a field). server process 100 receives confirmation from buyer 16 (step 116) and activates the payment agreement for the sales proposal. Buyer 16, seller 18, and financial institution 20 are notified that that future deliveries made under the payment agreement will be paid by financial institution 20 on the dates and per the terms set forth in the sales proposal. Server process 100, sends notification to buyer 16, seller 18, and financial institution 20 (step 118). The notification, for example, may be in the form of a message displayed on the Web portal 52.

Referring to FIGS. 5A-5B, an invoice payment procedure 130 by which seller 18 receives payment for a commodity purchased by buyer 16 under the payment agreement is described. A corresponding server process 150 performed by the guarantying logic 50 operating in combination with the verification logic 58, the Web client application 46, and the webpage application 52 is shown along side invoice payment procedure 130. A solid line connects each step of invoice payment procedure 130 to one or more corresponding steps of server process 150. Server process 150 may perform multiple steps to implement a single step of invoice payment procedure 130. Server process 150 is preferably executed on server computer 12, though some or all of the steps of server process 150 could be executed on one or more client devices 14.

At some point before seller 12 delivers the commodity to buyer 16, a payment guaranty sub-limit for financing the payment agreement is created (step 132) at service platform 12. The payment guarantee sub-limit includes a sub-credit limit that specifies the maximum value of credit made available to buyer 16 from financial institution 20 for financing the purchases of the commodity according to payment deadlines, delivery deadlines and the distribution of deliveries specified in the payment agreement. Server process 150 calculates the sub-credit limit to be supplied to buyer 16 (step 152). In calculating the sub-credit limit, server process 150 retrieves from memory 42 the amount of the overall credit limit supplied to buyer 16 from financial institution 20. Server process 150 calculates a sub-credit limit required to cover the full amount of the purchase as described in the payment agreement and stores this amount in memory 42. After a specific sub-limit has been stored for the payment agreement, server process 150 reduces the buyer's overall credit limit by the sub-credit limit amount.

Following a delivery of the commodity to buyer 16, seller 18 registers the completed delivery in service platform 12 (133). Server process 150 receives information pertaining to the deliver from seller 12 and stores the information in database 24 (step 153). Buyer 16 determines whether the delivery complies with the original sales proposal. If the delivery is deficient (e.g., the delivered product is damaged, incomplete, or incorrect), buyer 16 notifies seller 18, and seller 18 re-delivers the commodity. After determining that the delivery complies with the original sales agreement, buyer 16 approves the delivery (step 134). Server process 150 receives approval from buyer 16 and notifies seller that the delivery has been approved by buyer 16 (step 154). Seller 12 issues an electronic invoice for the delivery and notifies buyer 16 (step 136). Server process 150 receives the invoice from seller 18 (step 156a) and sends the invoice to buyer 18 for review (step 156b). Buyer 16 then reviews the invoice for accuracy. If buyer 16 notices a mistake in the invoice (e.g, an overcharge), buyer 16 notifies seller 18, and seller 18 sends a corrected invoice to buyer 16. If buyer 16 determines that the invoice is acceptable, buyer 16 enters approval of the invoice, and seller 18 and financial institution 20 are notified that the invoice has been approved (step 138). Server process 150 receives approval of the invoice from buyer 16 (step 158a) and sends notification of the approval to seller 18 and financial institution 20 (step 158b). Server process 150 authorizes financial institution 20 to pay seller 18 on behalf of buyer 16 for the commodity delivered to buyer 16 (step 158c). In this manner, financial institution 20 can be confident that the delivery was successfully completed before supplying payment to seller 12.

Following buyer approval of the invoice (step 138), financial institution 20 notifies seller 18, irrevocably, of the payment date, as specified in the payment agreement. On the specified date, financial institution 20 pays seller 18 for the amount of the invoice regardless of whether payment has been received from buyer 16 (step 140). Server process 150 receives the payment from financial institution 20 and routes the payment to the account of seller 18 (step 160a). Server process 150 then reduces the sub-credit limit by the invoice amount owed by buyer 16 to financial institution 20 (step 160b). Financial institution 20 charges the invoice amount to buyer 16 (step 142). Server process 150 notifies buyer 16 that the invoice has been paid by financial institution 20 (step 162). When seller 18 receives the payment for the invoice, seller 18 confirms receipt of the payment by sending service platform 12 notification that the payment has been received (step 144). Process 150 receives notification from seller 18 that the payment has been received (step 164). On or before the payment date specified by the payment agreement, buyer 16 pays financial institution 20 for the amount of the invoice and any additional interest or fees accrued (164). In some embodiments, buyer 16 pays financial institution directly 20 (e.g., through a direct money transfer). In other embodiments, the service platform 12 routes funds from an account owned by buyer 16 to an account owned by financial institution 20. Once the funds have been received by the financial institution 20, server process 150 receives notification that financial institution 20 has received the payment from buyer 16 (step 166a). After buyer 16 has paid the approved invoice, the corresponding sub-credit limit remains reduced by the invoice amount, but the server process 150 increases the overall credit limit of buyer 16 by the amount buyer 16 paid to financial institution 20, i.e., the invoice amount (step 166b). For example, if buyer 16 had paid less than the invoice amount to financial institution 20, the server process 150 would credit only the amount that had actually been paid by buyer 16 to the overall credit limit. In this example, an amount equal to invoice amount less the amount paid by buyer 16 would remain deducted from the buyer's overall credit limit.

As buyer 16 purchases commodities under the supply agreement, server process 150 reduces the sub-credit limit by the purchase amounts until the sub-credit limit is depleted. As buyer 16 pays financial institution 20 for purchases made under the supply agreement, server process 150 restores the overall credit limit of buyer 16 by the payment amounts. Furthermore, any amount remaining in the sub-credit limit that is unused after the sub-credit limit expires is credited to the buyer's overall credit limit. Thus, as long as buyer 16 pays financial institution 20 for all funds drawn under the sub-credit limit, the overall credit limit of buyer 16 is eventually restored to the original overall credit limit that was available before the sub-credit limit had been created. In one example, if buyer 16 spends the entire sub-credit limit and pays it back to the financial institution 20, the overall credit limit would be restored to the original credit limit. In another example, if buyer spends a portion of the of the sub-credit limit and pays it back, the remaining amount of the sub-credit limit would be credited to the overall credit limit of buyer 16 after the sub-credit limit expires. Thus, the overall credit limit of buyer 16 would be restored to its original value.

All subscribers to the guarantying service have individual work areas linked to their accounts in the service electronic platform 12 where they can access information. Information displayed in the work area of buyer 16 includes but is not limited to: the overall credit limit supplied by financial institution 20, the overall credit limit used/available, approved supply agreements entered under the guarantying service, the sub-credit limit per sales agreement, the amount of each sub-credit limit used per each corresponding sales agreement, the sub-credit limit remaining per supply agreement, invoices issued per sales agreement, invoices approved (e.g., overall and per agreement), and invoices pending approval. Information displayed in the work area of seller 18 includes but is not limited to: sales agreements entered under the guarantying service, credit limits used per supply agreement, invoices issued per supply agreement, invoices approved by buyers, invoices pending approval by buyers, invoices pending payment by financial institutions, and invoices paid by financial institutions. Information displayed in the work area of financial institution 20 includes but is not limited to: payment agreements for guarantying payment to sellers, overall credit limits supplied to buyers, sub-credit limits for sales agreements supplied to buyers, the sub-credit limit remaining per supply agreement, invoices issued by sellers per sales agreement, invoices pending authorization for payment, amount owed by buyer for paid invoices, amounts collected from buyers for paid invoices.

A number of embodiments of the invention have been described. Nevertheless, it will be understood that various modifications may be made without departing from the spirit and scope of the invention. The foregoing are examples for illustration only and not to limit the alternatives in any way.

The computer processes described herein, including server processes 100 and 150, can be implemented in digital electronic circuitry, or in computer software, firmware, or hardware, including the structural means disclosed in this specification and structural equivalents thereof, or in combinations of them. The processes can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes described herein, including method steps, can be performed by one or more programmable processors executing one or more computer programs to perform functions of the processes by operating on input data and generating output. The processes can also be performed by, and apparatus of the processes can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer-readable media suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The processes can be implemented in a computing system that includes a back end component (e.g., a data server), a middleware component (e.g., an application server), or a front end component (e.g., a client computer having a graphical user interface or a Web browser through which a user can interact with an implementation of the processes), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The steps of processes 80, 100, 130, and 150 may be performed in orderings other than those shown in corresponding FIGS. 4A-4B and 5A-5B. For examples, some of the steps of one or more of processes 80, 100, 130, and 150 may be eliminated or repeated. Elements of different embodiments described herein may be combined to form other embodiments not specifically set forth above. Accordingly, other embodiments are within the scope of the following claims.

What is claimed is:

1. A computer-implemented method for guaranteeing payment to a seller of a commodity purchased by a buyer, the method comprising:
receiving, from the buyer, a selection of a sales proposal for purchasing the commodity from the seller, the sales proposal specifying conditions under which the commodity will be delivered to the buyer;
notifying the seller that the sales proposal has been selected by the buyer;
providing, to the seller, a payment agreement specifying financial terms under which a financial institution guarantees payment to the seller on behalf of the buyer for future deliveries of the commodity in accordance with the sales proposal, the payment agreement being approved by the buyer and the financial institution;
receiving, from the seller, an acceptance of the payment agreement; and
notifying the buyer, the seller, and the financial institution that future deliveries of the commodity, as defined in the sales proposal, will be paid by the financial institution according to the payment agreement.

2. The method of claim 1, further comprising:
enabling the buyer to view a plurality of sales proposals for purchasing commodities from a plurality of different sellers.

3. The method of claim 1, further comprising:
enabling the buyer and the seller to negotiate terms of the sales proposal.

4. The method of claim 1, further comprising selecting the conditions specified in the sales proposal to include one or more of: a payment date, a delivery date, and a distribution of deliveries.

5. The method of claim 1, wherein notifying the seller further comprises inviting the seller to put the sales proposal under the payment agreement.

6. The method of claim 1, further comprising receiving payment from the buyer in return for providing the buyer access to a plurality of sales proposals made available by different sellers, the access to the plurality of sales proposals being provided over a predetermined period of time.

7. The method of claim 1, further comprising receiving payment from the seller in return for providing different buyers access to the sales proposal offered by the seller, the access to the sales proposal being provided over a predetermined period of time.

8. A computer-implemented method for funding a transaction between a buyer and a seller, the method comprising:
receiving an invoice issued by the seller for a commodity delivered to the buyer;
receiving, from the buyer, approval of the invoice, the approval indicating that the invoice accurately describes payment due for delivery of the commodity in accordance with a prior sales agreement between the buyer and the seller;
notifying a financial institution that the approval has been received from the buyer;
authorizing the financial institution to pay the seller an amount specified in the invoice regardless of whether the financial institution has received payment from the buyer; and
receiving notification that the seller has received payment from the financial institution for the amount specified in the invoice.

9. The method of claim 8, further comprising calculating a sub-credit limit that specifies a maximum value of credit made available to the buyer from the financial institution for financing the purchase of the commodity under the sales agreement, the sub-credit limit being supplied by the financial institution to the buyer.

10. The method of claim 9, wherein calculating the sub-credit limit comprises:
allocating a portion of an overall credit limit to be used as the sub-credit limit, the overall credit limit being supplied from the financial institution to the buyer.

11. The method of claim 10, further comprising:
transferring funds from an account owned by the financial institution to an account owned by the seller, the funds being in the amount specified in the invoice, the amount specified in the invoice being less than or equal to the credit limit; and
reducing the sub-credit limit by the amount specified in the invoice.

12. The method of claim 11, further comprising:
receiving notification that the financial institution has received payment from the buyer in the amount specified in the invoice; and
increasing the overall credit limit by the amount specified in the invoice.

13. The method of claim 9, further comprising defining terms under which the sub-credit limit is valid, the terms including one or more of: a payment deadline, a delivery deadline, a schedule of deliveries, and a duration of time over which the sub-credit limit is valid.

14. An apparatus for guaranteeing payment to a seller for a commodity purchased by a buyer, the apparatus comprising:
a processor operable to execute a computer program for facilitating transactions between the buyer, the seller, and a financial institution;
memory coupled to the processor, the memory operable to store the computer program;
a communication device operable to:
transmit information between a first client device and the processor, the first client device being operating by the buyer;
transmit information between a second client device and the processor, the second client device being operated by the seller;
transmit information between a third client device and the processor, the third client device being operated by the financial institution;
wherein the computer program includes computer instructions to cause the processor to:
receive selection data from the first client device, the selection data including a selection of a sales proposal made by the buyer for purchasing a commodity from the seller, the sales proposal specifying conditions under which the commodity will be delivered to the buyer;
transmit first notification data to the second client device, the first notification data notifying the seller that the sales proposal has been selected by the buyer;
transmit payment agreement data to the second client device, the payment agreement data specifying financial terms under which the financial institution guarantees payment to the seller on behalf of the buyer for future deliveries of the commodity in accordance with the sales proposal, the financial terms being approved by the buyer;
receive acceptance data from the second client device, the acceptance data indicating acceptance of the payment agreement by the seller; and
transmit second notification data to the first, second, and third clients, the second notification data notifying the buyer, the seller, and the financial institution that future deliveries of the commodity, as defined in the sales proposal, will be paid by the financial institution according to the financial terms.

15. The apparatus of claim 14, further comprising a network connected to the communication device and to the first, second, and third client devices, the network including the Internet and the World Wide Web.

16. The apparatus of claim 14, wherein the computer program includes further instructions to cause the processor to operate a web site portal through which the buyer, the seller, and the financial institution interact with each other.

17. The apparatus of claim 14, wherein the first, second, and third client devices store first, second, and third digital certificates, respectively, the digital certificates including personal identification used by the processor to electronically verify the identities of the buyer, the seller, and the financial institution.

18. The apparatus of claim 14, wherein the computer program includes further instructions to cause the processor to authenticate the buyer using an encrypted username and password supplied by the buyer.

19. The apparatus of claim 14, wherein the computer program includes further instructions to cause the processor to enable the buyer to view, at the first client device, a plurality of sales proposals for purchasing commodities from a plurality of different sellers.

20. The apparatus of claim 14, wherein the computer program includes further instructions to cause the processor to enable the buyer and the seller to negotiate terms of the sales proposal.

21. The apparatus of claim 14, wherein the computer program includes further instructions to cause the processor to store the conditions of the sales proposal in the memory, the conditions including one or more of: a payment date, a delivery date, and a distribution of deliveries.

22. The apparatus of claim 14, wherein the first notification data includes an invitation to the seller to put the sales proposal under the payment agreement.

23. An apparatus for funding a transaction between a buyer and a seller, the apparatus comprising:
a processor operable to execute a computer program for facilitating transactions between the buyer, the seller, and a financial institution;
a memory coupled to the processor, the memory operable to store the computer program;
a communication device operable to:
transmit information between a first client device and the processor, the first client device being operating by the buyer;
transmit information between a second client device and the processor, the second client device being operated by the seller;
transmit information between a third client device and the processor, the third client device being operated by the financial institution;
wherein the computer program includes computer instructions to cause the processor to:
receive invoice data from the second client device, the invoice data including an invoice issued by the seller for a commodity delivered to the buyer;
receive approval data from the first client device, the approval data indicating that the invoice accurately describes payment due for delivery of the commodity in accordance with a prior sales agreement between the buyer and the seller;
transmit first notification data to the third client device, the first notification data notifying the financial institution that approval has been received from the buyer;
transmit authorization data to the third client device, the authorization data authorizing the financial institution to pay the seller an amount specified in the invoice regardless of whether the financial institution has received payment from the buyer; and
receive second notification data from the second client device, the second notification data indicating that the seller has received payment from the financial institution for the amount specified in the invoice.

24. The apparatus of claim 23, further comprising a network connected to the communication device and to the first, second, and third client devices, the network including the Internet and the World Wide Web.

25. The apparatus of claim 23, wherein the computer program includes further instruction to cause the processor to operate a web site portal through which the buyer, the seller, and the financial institution interact with each other.

26. The apparatus of claim 23, wherein the first, second, and third clients store first, second, and third digital certificates, respectively, the digital certificates including personal identification used by the processor to electronically verify the identities of the buyer, the seller, and the financial institution.

27. The apparatus of claim 23, wherein the computer program includes further instructions to cause the processor to authenticate the buyer using an encrypted username and password supplied by the buyer.

28. The apparatus of claim 23, wherein the computer program includes further instructions to cause the processor to calculate a sub-credit limit that specifies a maximum value of credit made available to the buyer from the financial institution for financing the purchase of the commodity under the sales agreement, the sub-credit limit being supplied by the financial institution to the buyer.

29. The apparatus of claim 28, wherein the computer program includes further instructions to cause the processor to:
allocate a portion of an overall credit limit to be used as the sub-credit limit, the overall credit limit being supplied from the financial institution to the buyer.

30. The apparatus of claim 29, wherein the computer program includes further instructions to cause the computer system to:
transfer funds from an account owned by the financial institution to an account owned by the seller, the funds being in the amount specified in the invoice, the amount specified in the invoice being less than or equal to the credit limit; and
reduce the sub-credit limit by the amount specified in the invoice.

31. The apparatus of claim 30, wherein the computer program includes further instructions to cause the processor to:
receive notification that the financial institution has received payment from the buyer in the amount specified in the invoice; and
increase the overall credit limit by the amount specified in the invoice.

32. The apparatus of claim 28, wherein the computer program includes further instructions to cause the processor to store terms under which the sub-credit limit is valid, the terms including one or more of: a payment deadline, a delivery deadline, a schedule of deliveries, and a duration of time over which the sub-credit limit is valid.
